(19) United States
(12) Patent Application Publication
(10) Pub. No.: US 2006/0103306 A1
(43) Pub. Date: May 18, 2006

(54) Production of plasma display panel and method for making the same

(75) Inventors: Yu-Sheng Chen, Padeh City (TW); Chih-Hsiung Leu, Padeh City (TW); Chung-Wang Chou, Padeh City (TW)

Correspondence Address: BIRCH STEWART KOLASCH & BIRCH, PO BOX 747, FALLS CHURCH, VA, 22040-0747, US

(73) Assignee: Chunghwa Picture Tubes, Ltd.

(21) Appl. No.: 10/986,311

(22) Filed: Nov. 12, 2004

(51) Int. Cl. H01J 17/49; H01J 9/00; H01J 9/24

(52) U.S. Cl. 313/582; 313/586; 313/587; 445/24; 445/25

(57) ABSTRACT

The present invention discloses a plasma display panel and a method for making the same. The method comprises steps of: A first substrate is provided. Elongated electrodes are formed on the first substrate. An overcoat layer is formed on the elongated electrodes and the first substrate. Then, by means of screen print, a shaping layer of grid-mesh-shaped barrier rib is formed on the overcoat layer. Screen print is applied again to form a plurality of bumps on the shaping layer of grid-mesh-shaped barrier rib; A second substrate is also provided. The second substrate extends paralleled with the first substrate so as to define a discharge space between the first substrate and the second substrate after combining the two substrates. Bumps are provided between the first stripe rib areas and the second stripe rib areas so as to define passages to let air can flow in the discharge space. By the mentioned processes, bumps are provided between the first stripe rib areas and the second stripe rib areas so as to define passages for drawing air. The process is simple and easy for precise alignment.

### BACKGROUND OF THE INVENTION

1. Field of the Invention

The present invention relates to a plasma display panel and a method for making the same and, more particularly, to a grid-mesh-shaped barrier rib structure of the plasma display panel and a method for making the same.

2. Description of the Related Art

Most barrier rib structures of plasma display panel are a strip-shaped or a grid-mesh-shaped. As shown in FIG. 1, a perspective view of a conventional plasma display panel. A strip-shaped barrier rib 111 is formed on a rear substrate 110 and a grid-mesh-shaped barrier rib 121 is formed on a front substrate 120. And then combine the front substrate 120 with the rear substrate 110 to a plasma display panel 100. Several problems have been encountered by the conventional method.

Firstly, the front substrate 120 is expensive because it has to form a grid-mesh-shaped barrier rib 121. Secondly, it is difficult to combine the front substrate 120 with the rear substrate 110 since they must be precisely aligned. In order to precisely align the front substrate 120 with the rear substrate 110, the aperture ratio of the plasma display panel 100 is compromised since the thickness of the strip-shaped barrier rib 111 of the rear substrate 110 must be made big or the width of the grid-mesh-shaped barrier rib 121 of the front substrate 120 must be enlarged. The effective area of the substrates coated with phosphorous material is reduced as the thickness of the barrier ribs is increased.

As shown in FIG. 1B, a perspective view of another conventional plasma display panel. A grid-mesh-shaped barrier rib 161 is directly formed on a rear substrate 160 of the plasma display panel 150. Bumps 171 are also formed on the place of a front substrate 170 corresponding to that of concaves 162 of the grid-mesh-shaped barrier rib 161 of the rear substrate 160. And then combine the front substrate 170 with the rear substrate 160 to the plasma display panel 150. Some problems also have been encountered.

Firstly, the front substrate 170 is expensive since it needs to form the bumps 171. Secondly, it is difficult to combine the front substrate 170 with the rear substrate 160 since they must be aligned precisely.

The present invention is therefore intended to obviate or at least alleviate the problems encountered in prior art.

### SUMMARY OF THE INVENTION

It is an object of the present invention to provide a plasma display panel and a simple process for making the same that overcomes the above-mentioned problems.

Another object of the present invention is to provide a manufacturing method of forming passages on the grid-mesh-shaped barrier rib.

To achieve the above objects, according to the present invention, a plasma display panel includes a first substrate, a second substrate extending paralleled with the first substrate so as to define a discharge space between the first substrate and the second substrate, a plurality of elongated electrodes formed on the first substrate or the second substrate, and paralleled to a first direction, and a grid-mesh-shaped barrier rib formed on the elongated electrodes. The grid-mesh-shaped barrier rib includes a shaping layer and a plurality of bumps. In addition, the shaping layer includes a plurality of first stripe rib areas, which separates the discharge space into a plurality of sub discharge spaces and a plurality of second stripe rib areas, which defines channels. The channels and the first stripe rib areas are across. The thickness of the bumps defines the passages being communicated with the channels and the sub discharge spaces between the first substrate and the second substrate.

In the method according to the present invention, screen print is used to form a grid-mesh-shaped barrier rib. The method includes the following steps:

A first substrate is provided. The first substrate has a vent and formed a plurality of elongated electrodes. Each elongated electrode is paralleled to a first direction. An overcoat layer is formed on the elongated electrodes and the first substrate. And then form a shaping layer with channels of a grid-mesh-shaped barrier rib on the overcoat layer by means of screen print. Screen print is applied again to form bumps on the shaping layer as the grid-mesh-shaped barrier rib. A second substrate is provided. The first substrate is paralleled to and combined with the second substrate so as to define a discharge space between the first substrate and the second substrate. The discharge space is communicated with the vent. The edge of the first substrate is connected with the edge of the second substrate so as to close the discharge space. Each bump includes thickness H. Thus, passages with the thickness H are defined after combining of the first substrate and the second substrate, so that air can flow in the discharge space from the passages. And also air can be driven from the discharge space through the vent. In detail, air flows from the discharge space to the passages and from the passages to the channels. Finally, air flows through the vent.

The cost of screen print is cheap. Besides, there is no waste for the material of paste used on the screen print, because the paste is only printed on the specific areas.

Other objects, advantages and novel features of the present invention will become more apparent from the following detailed description referring to the attached drawings.

### BRIEF DESCRIPTION OF THE DRAWINGS

The present invention will be described via detailed illustration of embodiments referring to the drawings.

FIG. 1A is a perspective view of a conventional plasma display panel;

FIG. 1B is a perspective view of another conventional plasma display panel;

FIG. 2 is a perspective view of a partial structure of a front and a rear substrate of plasma display panel according to the present invention;

FIGS. 3A to 3C show steps of a method for making the grid-mesh-shaped barrier rib of plasma display panel according to the present invention; and

FIGS. 4A to 4C are perspective views of three different types of grid-mesh-shaped barrier rib.

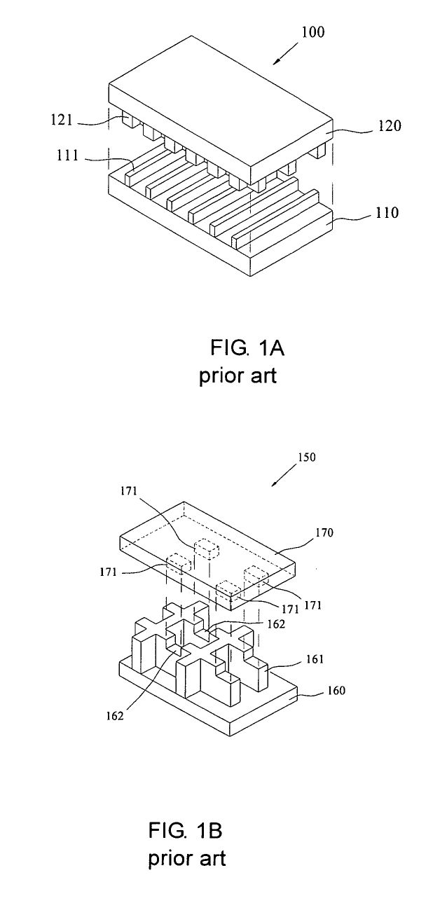

### DESCRIPTION OF THE PREFERRED EMBODIMENTS

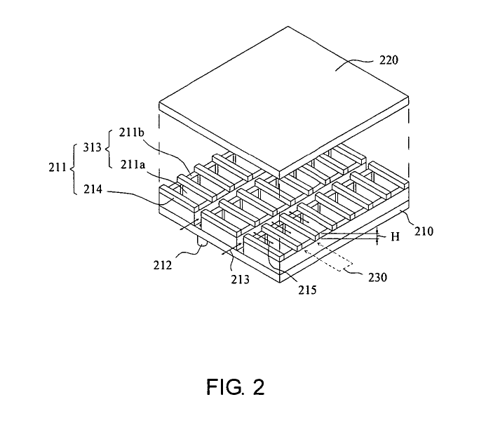

As shown in FIG. 2, the plasma display panel includes a first substrate 210 and a second substrate 220 paralleled with the first substrate 210 so as to define a discharge space. A vent 212, a plurality of elongated electrodes (not shown in the FIG. 2), and an overcoat layer are successively formed on the first substrate 210. Each elongated electrode is paralleled to a first direction (not shown in the FIG. 2) and a grid-mesh-shaped barrier rib 211 is formed on the overcoat layer. The grid-mesh-shaped barrier rib 211 of the first substrate 210 includes a plurality of first stripe rib areas 211a so as to define a plurality of sub discharge spaces 230 and a plurality of second stripe rib areas 211b intersecting the first stripe rib areas 211a; each second stripe rib area 211b defines a channel 213. A vent 212 is formed on one of the channels 213. Bumps 214, which include thickness H, are finally formed on the first stripe rib areas 211a and the second stripe rib areas 211b or the intersections of the first stripe rib areas 211a and the second stripe rib areas 211b.

Thus, passages 215 with thickness H are defined after combining of the first substrate 210 and the second substrate 220, so that air can flow to the channels 213 through the passages 215.

A method for making the plasma display panel according to the present invention includes the following steps:

Initially, there is provided a first substrate 210 with a vent 212 defined therein.

A plurality of elongated electrodes (not shown in the FIG.2) extends in a first direction on the first substrate 210.

An overcoat layer is formed on the elongated electrodes and the first substrate 210 (not shown in the FIG.2).

A grid-mesh-shaped barrier rib 211 is formed on the first substrate 210 by means of screen print. The grid-mesh-shaped barrier rib 211 is composed of a shaping layer 313 and a plurality of bumps 214. The shaping layer 313 includes the plurality of first stripe rib areas 211a and a plurality of second stripe rib areas 211b. Each second stripe rib area defines a channel 213.

There is provided a second substrate 220 paralleled with the first substrate 210 so as to define a discharge space between the first substrate 210 and the second substrate 220. The discharge space is communicated with the vent 212.

The edge of the first substrate 210 is connected with the edge of the second substrate 220 so as to close the discharge space. Each bump 214 includes thickness H. Thus, passages 215 with thickness H are defined after combining of the first substrate 210 and the second substrate 220, so that air can flow in the discharge space through the passages 215. For example, flow in the discharge space 230 and the channels 213.

Air is driven from the discharge space 230 through the vent 212. In detail, air flows from the discharge space 230 to the passages 215 and from the passages 215 to the channels 213. Finally, air flows out the discharge space through the vent 212.

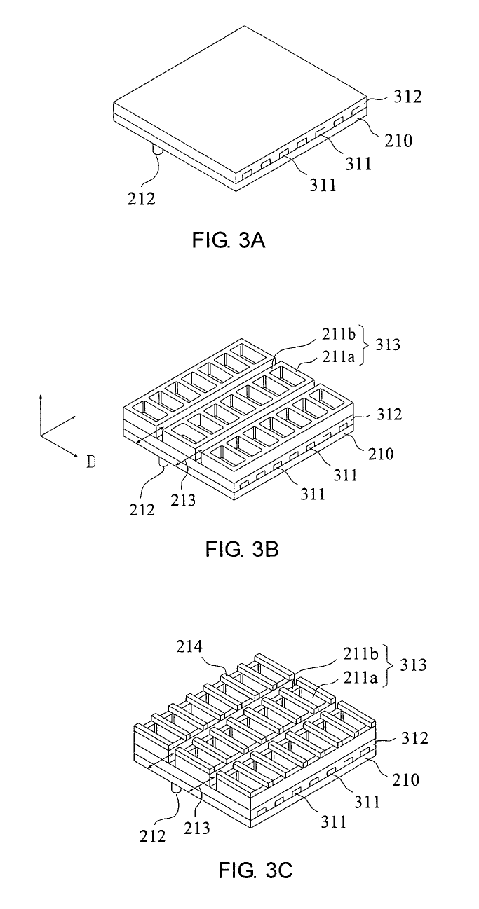

FIGS. 3A to 3C show steps of a method for making the grid-mesh-shaped barrier rib of plasma display panel according to the present invention.

As shown in FIG. 3A, a first substrate 210 is provided. A plurality of elongated electrodes 311 is formed on the first substrate 210. The elongated electrodes 311 extend in a first direction (shown as arrow D direction). An overcoat layer 312 is formed on the elongated electrodes 311 and the first substrate 210.

Then, as shown in FIG. 3B, a shaping layer 313 of grid-mesh-shaped barrier rib is formed on the overcoat layer 312 by means of screen print. The shaping layer 313 includes a plurality of first stripe rib areas 211a and a plurality of second stripe rib areas 211b intersecting the first stripe rib areas 211a. Each first rib area 211a is formed on a portion of the overcoat layer 312 between any two adjacent elongated electrodes 311. The first stripe rib areas 211a extend in a first direction. The second rib areas 211b extend in a second direction perpendicular to the first direction. Each second stripe rib area 211b defines a channel 213. Finally, as shown in FIG. 3C, by means of screen print again, bumps 214 are formed on the shaping layer 313 due to the cohesion of paste.

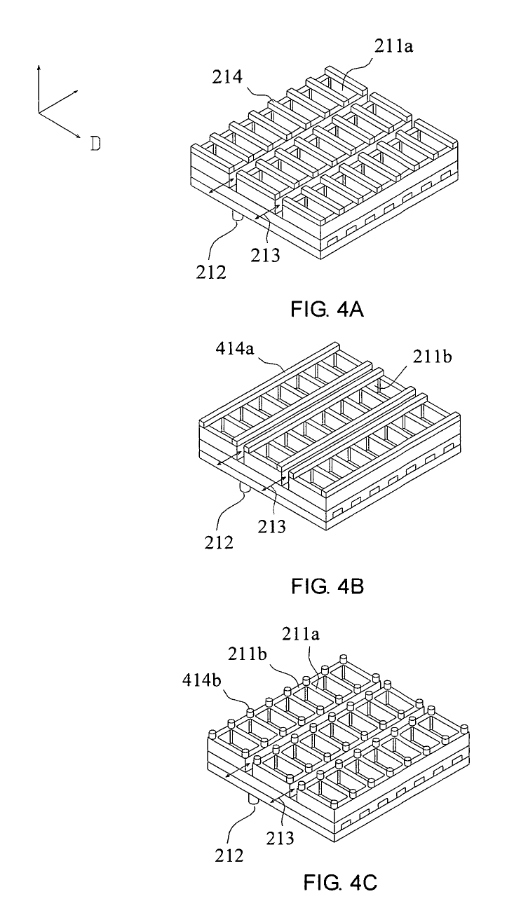

FIGS. 4A to 4C show three different types of forming the grid-mesh-shaped barrier rib 211.

As shown in FIG. 4A, elongated bumps 214 are formed on each first stripe rib area 211a by means of screen print along a first direction (shown as arrow D). Because of the cohesion of paste, the paste will not flow into the channels 213 but adhere to the first stripe rib areas 211a.

As shown in FIG. 4B, elongated bumps 414a are formed on each second stripe rib area 211b a by means of screen print along a second direction. Because of the cohesion of paste, the paste will only adhere to the second stripe rib areas 211b.

As shown in FIG. 4C, bumps 414b are formed on each intersection of first stripe rib area 211a and related one of the second stripe rib area 211b. In detail, a plurality of drops of paste are provided on intersections of the first stripe rib areas 211a and the second stripe rib areas 211b to form the bumps 414b.

According to the above manufacturing methods of the grid-mesh-shaped barrier rib, the present invention has following advantages:

Only the rear substrate needs to form stripe ribs, so it is easier for precisely aligned combining of the front substrate and the rear substrate.

Passages formed by the bumps of stripe rib areas are easier to draw air out of the discharge space during the vacuum process of plasma display panel assembly.

The process for forming the rid-mesh-shaped barrier rib is simple. Because of the character of cohesion of paste, the line width on the silk screen can be designed more big than that of the stripe ribs, which will cause a better alignment; moreover, the job can be done by applying twice screen print.

The present invention has been described via detailed illustration of some embodiments. Those skilled in the art can derive variations from the embodiments without departing from the scope of the present invention. Therefore, the embodiments shall not limit the scope of the present invention defined in the claims.

What is claimed is:

1. A plasma display panel, comprising:
a first substrate;
a second substrate extending paralleled with said first substrate so as to define a discharge space between said first substrate and said second substrate;
a plurality of elongated electrodes formed on said first substrate or said second substrate and each elongated electrode extends in a first direction; and
a grid-mesh-shaped barrier rib formed on said elongated electrodes, wherein said grid-mesh-shaped barrier rib consists of:
a shaped layer; and
a plurality of bumps with thickness H formed on said shaped layer to define passages between said first substrate and said second substrate, wherein said passages are communicated with said discharge space.

2. The plasma display panel according to claim 1 wherein said shaping layer further comprises:
a plurality of first stripe rib areas along a first direction which separate said discharge space into a plurality of sub discharge spaces;
a plurality of second stripe rib areas intersecting said first stripe rib areas; wherein each of said second stripe rib areas defines a channel.

3. The plasma display panel according to claim 2 wherein said bumps are elongated bumps formed on said first stripe rib areas.

4. The plasma display panel according to claim 2 wherein said bumps are elongated bumps formed on said second stripe rib areas.

5. The plasma display panel according to claim 2 wherein said bumps are formed on intersections of said first stripe rib areas with said second stripe rib areas.

6. The plasma display panel according to claim 1 wherein said plurality of elongated electrodes formed an overcoat layer on above.

7. A method for making a plasma display panel, the method comprising steps of:
providing a first substrate defining a vent;
providing a plurality of elongated electrodes extending in a first direction on said first substrate;
forming an overcoat layer on said elongated electrodes and said first substrate;
applying screen print to form a shaping layer of grid-mesh shape containing with channels on said overcoat layer;
applying screen print again to form a plurality of bumps on said shaping layer as grid-mesh-shaped barrier ribs;
providing a second substrate extending paralleled with said first substrate so as to define a discharge space between said first substrate and said second substrate, said discharge space being communicated with said vent;
connecting an edge of said first substrate with an edge of said second substrate so as to close said discharge space, wherein the thickness of said bumps is defined as said passages after combining of said first substrate and said second substrate and air can flow to said channels from said passages in said discharge space; and
extracting air from said discharge space through said vent, wherein air flows from said discharge space to said passages and from said passages to said channels, and finally flows through said vent.

8. The method according to claim 7 wherein said step of applying screen print again to form a plurality of bumps on said shaping layer containing with channels on said overcoat layer said shaping layer further comprises:
forming a plurality of first stripe rib areas and a plurality of second stripe rib areas;
each of said first stripe rib areas being disposed between every two stripe-shaped electrodes, and being paralleled to a first direction;
each of said second stripe rib areas being paralleled to a second direction and being substantially perpendicular to said first direction;
and
each of said second stripe rib areas having a channel.

9. The method according to claim 7 wherein said bumps are elongated bumps formed on said first stripe rib areas by means of screen print.

10. The method according to claim 7 wherein said bumps are elongated bumps formed on said second stripe rib areas by means of screen print.

11. The method according to claim 7 wherein said bumps are formed on intersections of said first stripe rib areas and said second stripe rib areas by means of screen print.

12. The method according to claim 8 wherein said shaping layer further comprises steps of:
print a plurality of layers of paste on said shaping layer; and
baking the layers of paste.

13. The method according to claim 7 wherein said bumps further comprises steps of:
providing drops of paste on said shaping layer; and
baking the drops of paste.
